(19) United States
(12) Patent Application Publication
(10) Pub. No.: US 2021/0028446 A1
(43) Pub. Date: Jan. 28, 2021

(54) LITHIUM ION BATTERY ELECTRODE

(71) Applicants: Xinhua LIANG, Rolla, MO (US); Rajankumar L. PATEL, Richland, WA (US)

(72) Inventors: Xinhua LIANG, Rolla, MO (US); Rajankumar L. PATEL, Richland, WA (US)

(21) Appl. No.: 15/999,095

(22) PCT Filed: Feb. 21, 2017
(86) PCT No.: PCT/US2017/018642

§ 371 Date: Aug. 17, 2018

Related U.S. Application Data
(60) Provisional application No. 62/297,817, filed on Feb. 20, 2016.

(51) Int. Cl. H01M 4/36; H01M 10/0525; H01M 4/505; H01M 4/525; H01M 4/48; C01G 53/00

(52) U.S. Cl. CPC H01M 4/366; H01M 10/0525; H01M 4/505; H01M 2004/021; H01M 4/483; C01G 53/52; H01M 4/525

(57) ABSTRACT

Disclosed herein are a method of transition metal doping while simultaneously forming an ultra-thin film coating of the transition metal oxide using atomic layer deposition (ALD) on lithium ion battery (LIB) electrode particles; a product formed by the disclosed method; and the synergetic effect of the transition metal doping simultaneously with forming the ALD ultra-thin film transition metal oxide coating.

### RELATED APPLICATION

This application claims the benefit of U.S. Provisional Application No. 62/297,817 filed on Feb. 20, 2016, the teachings of which are incorporated herein by reference in their entirety.

### BACKGROUND OF THE INVENTION

LiMn_{1.5}Ni_{0.5}O₄, referred to herein as “LMNO”, has been explored as an electrode material for lithium ion batteries (LIBs) due to its improved cycling behavior relative to the pristine spinet. The nominal cost, enhanced thermal stability, enhanced rate capability owing to its three-dimensional structure, and the operating voltage window of LMNO make it a potential candidate for use in hybrid electric vehicles (HEV). However, it has not gained commercial usability in HEV due to high capacity fade during cycling at elevated temperatures and Mn³⁺ dissolution by HF. High capacity fade during cycling is also a problem with other currently available electrode materials such as LiCoO₂, LiMn₂O₄, Li₄Ti₅O₁₂, Li₂MnO₃, and LiNiMnCoO₂.

Doping LMNO with ions has been considered to better the core properties of LMNO for enhanced electrochemical performance. However, doping alone cannot significantly improve the cycleability and capacity retention of LMNO or other LIB electrodes because it cannot avoid dissolution of Mn³⁺ ions by HF. Several researchers have used wet chemical methods including sol-gel methods to coat protective film over pristine LMNO. Although the protective coating improved cycling life and capacity retention of LMNO, there was always an unfortunate trade-off between decreasing the capacity and increasing cycle life of the battery. In these studies, the films were not conformally coated on the particle surfaces, and it was difficult to precisely control the thickness of the coating. The increased thickness causes increased mass transfer resistance that delays the movement of species, electrons, and ions.

A sol-gel method has been used to form an iron oxide coating on carbon nanorods and on SnO₂ particles, but the resulting coatings were not sufficient to solve the afore-mentioned problems.

### SUMMARY OF THE INVENTION

Disclosed herein is an electrode comprising at least one electrode particle, the at least one electrode particle comprising: a source of lithium ions, a coating of an oxide of a transition metal on the surface of the electrode particle, and the transition metal ions and/or the elemental transition metal doped under the surface of the electrode particle.

We have now discovered: a method of transition metal doping of lithium ion battery (LIB) electrode particles while simultaneously, using atomic layer deposition (ALD) on the LIB electrode particles, forming an ultra-thin film coating of the transition metal oxide on the LIB electrode particles so as to effect a synergistic or synergetic result. We have also discovered a product formed by the disclosed method, the product exhibiting the synergetic effect of the transition metal doping. In one embodiment of the invention, the transition metal is iron, and the ultra-thin film coating is iron oxide. In other embodiments, the transition metal doped may be, for example, cobalt or nickel, and the simultaneously deposited ultra-thin coating is cobalt oxide or nickel oxide, respectively.

In a fluidized bed reactor by ALD, we coated large quantities of LIB electrode particles with ultra-thin iron oxide films. We also disclose our discovery of a unique phenomenon of iron ions, and possibly elemental iron, entering the lattice structure of the LIB electrode particles during the ALD coating process. Herein we disclose evidence that the combined effect of the surficial partial doping of iron ions and/or elemental iron into the LIB electrode particles, along with the conductive optimal ultrathin coating of iron oxide films has significantly enhanced cycleability and reduced capacity fade of the LIB electrodes.

In one embodiment of the invention, the doping of iron ions and/or elemental iron into the LIB electrode particles during ALD comprises a penetration of the ionic Fe and/or elemental iron into the lattice structure of the LIB electrode particles. In another embodiment of the invention, during initial ALD cycles, the ionic Fe and/or elemental iron saturates a plurality of structural defects in the LIB electrode particle lattice structure, and then participates in formation of an ultrathin film of iron oxide on the LIB electrode particle surface.

In another embodiment of the invention, the doping of ionic Fe and/or elemental iron during the ALDcoating process is near the surface of the LIB electrode particles. The expression “near the surface,” as used herein means that some of the doped ionic Fe and/or elemental iron are on the surface of LIB electrode particles and some of the doped ionic Fe and/or elemental iron have penetrated beneath the surface of the LIB electrode particles, and some of the doped ionic Fe and/or elemental iron have penetrated inside the lattice structure of the LIB electrode particles.

The invention inter al/a includes the following, alone or in combination. One embodiment of the invention is an electrode particle comprising: a source of lithium ions, a coating of iron oxide on the surface of the electrode particle, and iron ions and/or elemental iron doped under the surface of the electrode particle.

In another embodiment of the invention the source of lithium ions comprises LiMn_{1.5}Ni_{0.5}O₄ (LMNO).

In another embodiment of the invention the source of lithium ions comprises at least one of LiCoO₂, LiMn₂O₄, Li₄Ti₅O₁₂, Li₂MnO₃, Lithium Nickel Manganese Cobalt Oxide (LiNiMnCoO₂ or NMC), and a layered LiMO₂ component or a spinel LiM₂O₄ component, wherein “M” is predominantly Mn and/or Ni.

In yet another embodiment of the invention, the source of lithium ions comprises LiNiₓCo_{y}Al_{z}Oₐ, for example, LiNiCoAlO₂, or LiNi_{0.8}Co_{0.15}Al_{0.05}O₂.

Another embodiment of the invention is an electrode comprising particles comprising LiMn_{1.5}Ni_{0.5}O₄, a coating of iron oxide on the surface of the particles, and elemental iron or iron ions doped under the surface of the particles.

An electrode according to an embodiment of the invention may comprise a metal or a carbon substrate at least partially coated with a mixture comprising a plurality of electrode particles, each electrode particle comprising a source of lithium ions, a coating of iron oxide on the surface of the electrode particle, and iron ions and/or elemental iron doped under the surface of the electrode particle; and a polymer binder. Almost any other transition metal may be suitable for use in an embodiment of the disclosed invention.

In various embodiments of the invention, ALD may be used to deposit an ultra-thin coating of almost any transition metal oxide onto the LIB electrode particles, while simultaneously doping the atoms or ions of that same transition metal beneath the LIB particle surface. In one embodiment of the invention, a LIB electrode particle comprises an iron oxide film coating of from about 0.1 nanometer to about 500 nanometers.

In another embodiment of the invention, a LIB electrode particle comprises an iron oxide film coating of from about 0.2 nanometer to about 1 nanometer.

In another embodiment of the invention, a LIB electrode particle comprises an iron oxide film coating of from about 0.2 nanometer to about 200 nanometer.

In another embodiment of the invention, a LIB electrode particle comprises an iron oxide film coating of from about 0.4 nanometer to about 100 nanometers.

In another embodiment of the invention, a LIB electrode particle comprises an iron oxide film coating of from about 0.6 nanometer to about 50 nanometers.

In another embodiment of the invention, a LIB electrode particle comprises an iron oxide film coating of about 0.6 nanometer.

Another embodiment of the invention is an electrode comprising: a metal or a carbon substrate at least partially coated with a mixture comprising a plurality of electrode particles, each electrode particle comprising a source of lithium ions, a coating of iron oxide on the surface of the electrode particle, and iron ions and/or elemental iron doped under the surface of the electrode particle; and a polymer binder.

Another embodiment of the invention is an electrode according to paragraph [0014], wherein the metal or carbon substrate is at least partially coated with a mixture comprising, respectively, an 80:10:10 weight percent (wt. %) mixture of LiMn_{1.5}Ni_{0.5}O₄, carbon black, and a polymer binder.

Another embodiment of the invention is an electrode according to paragraph [0014], wherein the metal or carbon substrate is least partially coated with a mixture comprising from about 10 wt. % LiMn_{1.5}Ni_{0.5}O₄ to about 90 wt. % LiMn_{1.5}Ni_{0.5}O₄, carbon black, and a polymer binder.

Yet another embodiment of the invention is a method of preparing, in a fluidized bed reactor by ALD, electrode particles comprising: a source of lithium ions, a coating of iron oxide on the surface of the electrode particle, and iron ions doped under the surface of the electrode particle.

Yet another embodiment of the invention is a method of preparing, in a fluidized bed reactor by ALD, electrode particles comprising: a source of lithium ions, a coating of a transition metal oxide, such as, for example, nickel oxide (NiO) or cobalt oxide (CoO) on the surface of the electrode particle, and, the transition metal ion doped under the surface of the electrode particle. For example, respectively, nickel ions or cobalt ions are doped under the surface of the electrode particle. That is, Ni ion doping with NiO film coating would occur for a NiO ALD process; and Co ion doping with CoO film coating would occur for a CoO ALD process.

The disclosed process of simultaneously coating and doping LIB electrode particles in a single step using an ALD process can be used to prepare many different lithium ion battery electrodes, with little or only routine experimentation needed to adjust parameters.

The present invention has many advantages. The ALD coated samples prepared by the disclosed method demonstrated both higher initial capacity and longer cycle life with improved stable performance for more than 1,000 cycles of electrochemical cycling at room temperature and at 55° C.

### BRIEF DESCRIPTION OF THE DRAWINGS

The foregoing and other objects, features and advantages of the invention will be apparent from the following more particular description of illustrative embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram showing: (A) an uncoated LMNO particle, (B) the LMNO particle with iron ion or elemental iron doped under the surface, and (C) the LMNO particle coated with iron oxide and with iron ions doped under the surface.

FIG. 2 is a schematic representation of an electrode comprising particles comprising LiMn_{1.5}Ni_{0.5}O₄, a coating of iron oxide on the surface of the particles, and iron ions or elemental iron doped under the surface of the particles.

FIG. 3A is a transmission electron microscopy (TEM) image of uncoated LiMn_{1.5}Ni_{0.5}O₄ particles.

FIG. 3B is a TEM image of coated LiMn_{1.5}Ni_{0.5}O₄ particles with 160 cycles of iron oxide ALD.

FIG. 3C is a cross-sectional TEM image of one coated LiMn_{1.5}Ni_{0.5}O₄ particle with 160 cycles of iron oxide ALD.

FIG. 3D is Fe element mapping of cross-sectioned surface of one coated LiMn_{1.5}Ni_{0.5}O₄ particle with 160 cycles of iron oxide ALD by energy dispersive x-ray spectroscopy (EDS).

FIG. 3E is Fe EDS line scanning along the white horizontal line (as shown in FIG. 3C) of one coated LiMn_{1.5}Ni_{0.5}O₄ particle with 160 cycles of iron oxide ALD.

FIG. 4 shows powder XRD (PXRD) patterns of the uncoated LiMn_{1.5}Ni_{0.5}O₄ particles and LiMn_{1.5}Ni_{0.5}O₄ particles coated. with different cycles of ALD iron oxide.

FIG. 5A shows galvanostatic discharge capacities of cells made of LiMn_{1.5}Ni_{0.5}O₄ particles coated with different thicknesses of iron oxide at different C rates in a voltage range between 3.5-5 V at room temperature.

FIG. 5B shows the respective normalized discharge capacity of the cells of FIG. 5A vs. C rate curves.

FIG. 5C shows galvanostatic discharge capacities of cells made of LiMn_{1.5}Ni_{0.5}O₄ particles coated with different thicknesses of iron oxide at different C rates in a voltage range between 3.5-5 V at 55° C.

FIG. 5D shows the respective normalized discharge capacity of the cells of FIG. 5C vs. C rate curves.

FIG. 6A shows galvanostatic discharge capacities of cells made of LiMn_{1.5}Ni_{0.5}O₄ particles coated with different thicknesses of iron oxide at a 1C rate in a voltage range between 3.5-5 V at room temperature.

FIG. 6B shows data from the experiment of 6A at 55° C.

FIG. 7A shows galvanostatic discharge capacities of cells made of LiMn_{1.5}Ni_{0.5}O₄ particles coated with different thicknesses of iron oxide at a 2C rate in a voltage range between 3.5-5 V at room temperature.

FIG. 7B shows data from the experiment of 7A at 55° C.

FIG. 8A shows electrochemical impedance spectra at room temperature for uncoated (lowest curve) and LiMn_{1.5}Ni_{0.5}O₄ particles coated with various thicknesses of iron oxide after first cycle; and inset images show the high frequency regions (1M Hz-100 Hz) of the impedance spectra.

FIG. 8B shows data from the experiment of 8A after the 1,000^{th} charge-discharge cycles; and inset images show the high frequency regions (1M Hz-100 Hz) of the impedance spectra.

FIG. 8C schematically represents the equivalent circuit fit for the impedance spectra.

FIG. 9A shows electrochemical impedance spectra at 55° C. for uncoated LiMn_{1.5}Ni_{0.5}O₄ particles and for LiMn_{1.5}Ni_{0.5}O₄ particles coated with various thicknesses of iron oxide before charge-discharge; and inset images show the high frequency regions (1M Hz-100 Hz) of the impedance spectra.

FIG. 9B shows data from the experiment of 9A after 1,000^{th} charge-discharge cycles; and inset images show the high frequency regions of the impedance spectra.

FIG. 10A shows the .Arrhenius plot of uncoated and 30Fe, 40Fe, 80Fe, and 160Fe coated LiMn_{1.5}Ni_{0.5}O₄ particles for the effects of temperature on conductivity.

FIG. 10B schematically represents the equivalent circuit for impedance spectra.

FIG. 11A shows selective area electron diffraction (SAED) patters from TEM images of uncoated LiMn_{1.5}Ni_{0.5}O₄particles.

FIG. 11B shows SAED patterns from TEM images of 160 cycles of iron oxide ALD coated LiMn_{1.5}Ni_{0.5}O₄ particles.

FIG. 12 is a graphical representation of the iron content on LiM_{1.5}Ni_{0.5}O₄ particles versus the number of ALD coating cycles.

FIG. 13 shows Fe 2p XPS spectra of uncoated LiMn_{1.5}Ni_{0.5}O₄, and 30, 40, and 80 cycles of iron oxide ALD coated LiMn_{1.5}Ni_{0.5}O₄ samples.

FIG. 14 shows Mössbauer spectrum of coated LiMn_{1.5}Ni_{0.5}O₄particles with 160 cycles of iron oxide ALD. The results show a sextet and a doublet site at the center.

### DETAILED DESCRIPTION

A description of preferred embodiments of the invention follows. It will be understood that the particular embodiments of the invention are shown by way of illustration and not as limitations of the invention. At the outset, the invention is described in its broadest overall aspects, with a more detailed description following.

The present invention is directed to conformal films of iron oxide coated on LMNO particles in a fluidized bed reactor by means of atomic layer deposition.

The inventors of the disclosed subject matter herein report their discovery of the synergetic or synergistic effect of the combination of forming by ALD an electrochemically active transition metal oxide film, for example, an iron oxide film coating on LIB particles, for example, LiMn_{1.5}Ni_{0.5}O₄ (LMNO) particles, while simultaneously doping transition metal ions, for example, iron ions or elemental iron into the LMNO particles. In one embodiment of the invention, the doping of iron ions or elemental iron into the LMNO particles is surficial and partial. The elemental iron or the ionic Fe penetrates into the lattice structure of LMNO during initial ALD cycles. The elemental Fe or the ionic Fe further penetrates into the lattice structure of LMNO with the increasing number of ALD coating cycles. After the structural defects of the LMNO lattice are saturated, the transition metal, for example, iron (elemental Fe or ionic Fe) participates in formation of ultrathin films on LMNO particle surface. Owing to the conductive nature of iron oxide film, having the optimal film thickness of approximately 0.6 nm, the initial capacity improved by about 17% at room temperature (RT) and by about 24% at elevated temperature of 55° C. at 1C cycling rate. We herein disclose that the synergy of doping of LMNO particles with Fe ions surficially, that is, near the particle surface, combined with the conductive and protective nature of the optimal iron oxide film leads to unexpectedly high capacity retention (˜98% at RT and ˜95% at elevated temperature) even after 1,000 cycles at 1C cycling rate.

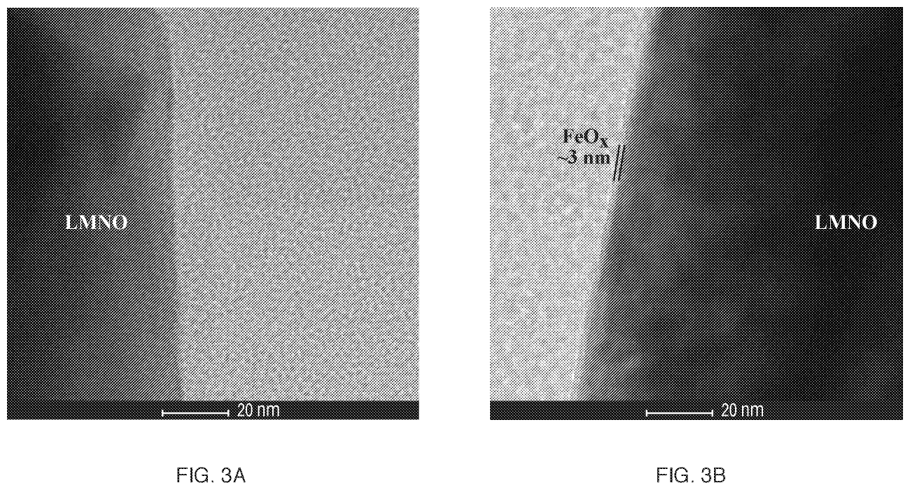

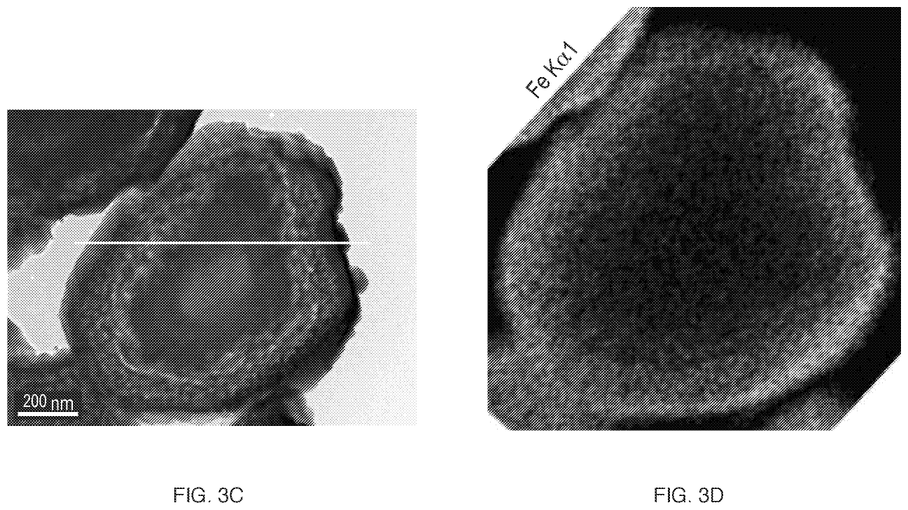

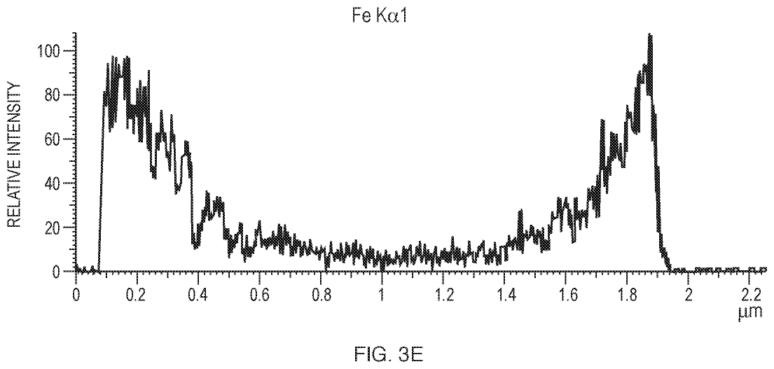

Iron oxide films coated on LiMn_{1.5}Ni_{0.5}O₄ particles: Different numbers of iron oxide ALD coating cycles were applied on the surfaces of LMNO particles (4-5 μm, NANOMYTE® SP-10, NEI Corporation). ALD reaction was carried out in a fluidized bed reactor by atomic layer deposition. Ferrocene and oxygen were alternately dosed into the reactor at a temperature of about 450° C. for 10 (10Fe), 20 (20Fe), 25 (25Fe), 30 (30Fe), 40 (40Fe), 80 (80Fe), and 160 (160Fe) cycles. The transmission electron microscopy (TEM) image of an uncoated (UC) LMNO particle, shown in FIG. 3A, displays a blank edge of a pristine particle. In contrast, a distinctive conformal coating of an approximately 3 nanometer (nm) layer on a LMNO particle after 160 cycles of iron oxide ALD, is seen in FIG. 3B. Images (not included herein) at different magnification levels for one particle show that the iron oxide coating was conformal and covering the entire particle surface. Based on this 160Fe sample, the growth rate of iron oxide films on the LMNO particles was approximately 0.02 nm/cycle. The iron oxide growth rates are in sync with the previously reported values. The growth rate values are derived from TEM images only, and because the ALD process experiences a nucleation period in the beginning of the cycles, the growth rate values do not represent the actual number of layers. FIG. 11A and FIG. 11B show the SAED pattern from TEM images of those two samples. Both powders exhibited well-developed octahedral shapes, although a secondary phase appeared to grow on the corner of the octahedral particle after coating 160 cycles of iron oxide ALD, as indicated in FIG. 11B.

In order to confirm the diffusion and distribution of iron inside the particle structure, about 80 nm thick thin section across the center of the 160Fe sample particle was cut using focused-ion beam (FIB) and elemental mapping was performed using energy dispersive x-ray spectroscopy (EDS). FIG. 3C is the regular TEM image of the thin-section across the center of a particle. FIG. 3D is the Fe elemental map of the same particle as shown in FIG. 3C, acquired in the scanning TEM (STEM) mode combined with EDS collection. FIG. 3E is the Fe element distribution along the red line as shown in FIG. 3C, and EDS line scan in the STEM mode was used to acquire this information. It clearly shows the Fe penetration approximately 400 nm deep below the 160Fe LMNO particle surface. The EDS spectra (not included herein) from the surface vicinity of the uncoated and the 160Fe samples indicated that there was no Fe in the uncoated sample, while there was a large amount of Fe on the particle surface of the 160Fe sample. This study in addition to the TEM images (as in FIG. 3B) provides evidence needed to support the claim that the doping and coating both occurred during the ALL) coating process.

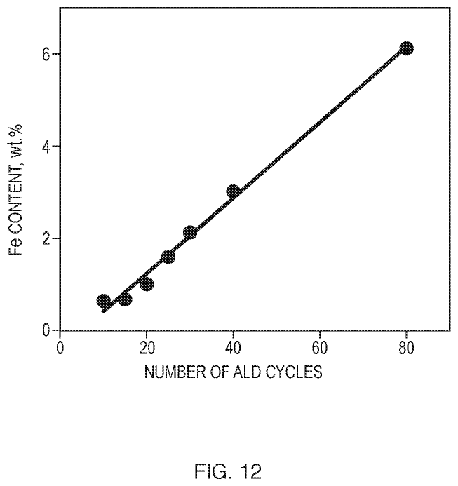

The Fe content on the LMNO particles was measured using inductively coupled plasma atomic emission spectroscopy (ICP-AES). As shown in FIG. 12, iron content increased almost linearly with increase in the number of ALD cycles. The thicknesses of iron oxide films were reflected by the content of Fe on the particles. The iron oxide film thickness was several magnitudes smaller than the 4-5 micron sized electrode particles. The plot trend clearly indicated the linear growth rate of the iron oxide ALD films onto the particles surface except for the short initial period for the first 10 ALD cycles. The surface area of the uncoated (UC) samples was 1.8 m²/g measured by using Quantachromc Autosorb-1.

Based on the surface area of particles, percentage of Fe in the 160Fe sample obtained from ICP-AES, and assuming the oxide films being Fe₃O₄, the expected thickness of the ultrathin film was found to be about 6 nm. However, the TEM analysis showed the film thickness to be only 3 nm. This discrepancy also indirectly supported that Fe had entered the lattice structure of LMNO. To our knowledge, this unique phenomenon, doping of iron in LMNO has not been previously reported as having occurred during an ALD coating process.

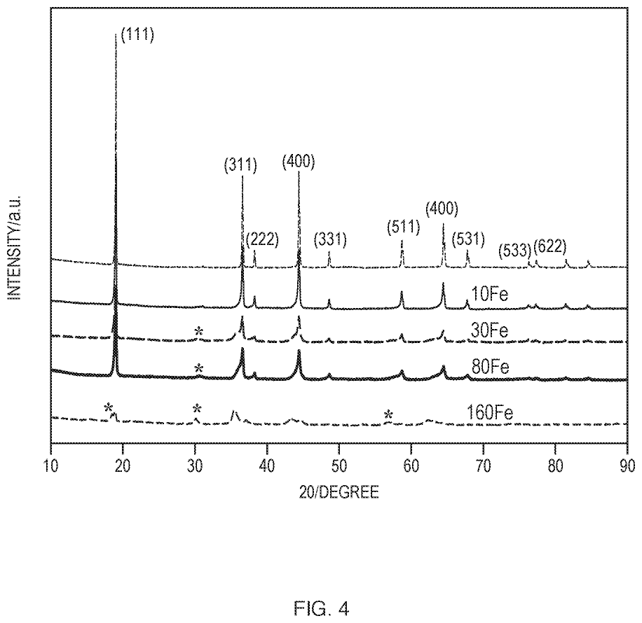

The ALD reaction was carried out for 10 (10Fe), 30 (30Fe), 80 (80Fe), and 160 (160Fe) cycles, FIG. 4 shows the powder X-ray diffraction (PXRD) pattern of the uncoated (UC), 10Fe, 30Fe, 80Fe, and 160Fe samples. For example, 10Fe represents the particles coated with 10 cycles of iron oxide ALD. The dominant Fe₃O₄ phase due to iron oxide ALD coating is indicated by “*”.

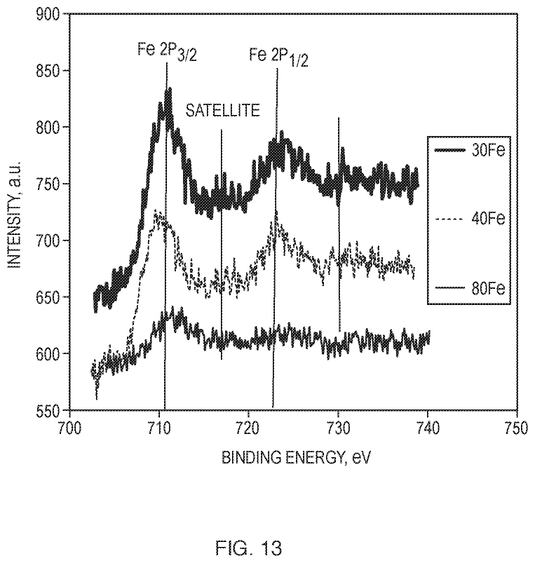

The PXRD patterns of pristine and modified samples confirm the existence of cubic spinel structure. All the main diffraction peaks are sharp, which indicates that the tested samples are well-crystallized. The pattern for the UC differs significantly from the 160Fe sample. For the 160Fe sample, the main peaks are not so sharp and some of the peaks have a significant shift in their position, indicating a significant amount of Fe was doped or diffused into the LMNO structure. The weak reflections observed at around 18.2°, 30°, and 57.5° in the 160Fe sample are absent in the 10⁻Fe sample and only 30° peak in 30Fe and 80Fe. The presence of Fe₃O₄ was confirmed for the case of 160Fe by the additional peaks at 30° and 57.5°, which are consistent with reported results. The PXRD patterns, consistent with the SAED pattern, indicate that the iron oxide ALD coated LMNO does not have the same phase as its uncoated counterpart. X-ray photoelectron spectroscopy (XPS) results shown in FIG. 13 further confirmed the presence of Fe₃O₄ phase (or a mixture of FeO and Fe₂O₃) in the 160Fe sample. For 30Fe and 40Fe, the Fe content was much lower than that of 160Fe, and PXRD showed very weak peaks to indicate the presence of Fe. Iron content in 10Fe was too low to detect any particular iron oxide phase confidently. This could be explained by the fact that the ALD deposition of iron oxide using ferrocene and oxygen precursor at high temperature (in this case 450° C.) resulted in Fe₂O₃ and which could be easily converted to Fe₃O₄, as evidence from the PXRD, which could be pure Fe₃O₄ spinel with Feₜₑₜ³⁺[Fe²⁺Fe³⁺]_{oct}O₄ (magnetite) composition, a defect non-stoichiometric spinel, Fe₃₋ₓO₄ or γ-Fe₂O₃ (maghemite). γ-Fe₂O₃ is the end member of non-stoichiometric Fe₃₋ₓO₄, given as Feₜₑₜ³⁺[Fe_{5/3}³⁺□_{1/2}]_{oct}O₄ (□ represents vacant site). Unfortunately, PXRD of these phases have subtle differences, which make it difficult to distinguish between them especially when the amount of Fe-content is less and particle sizes are small.

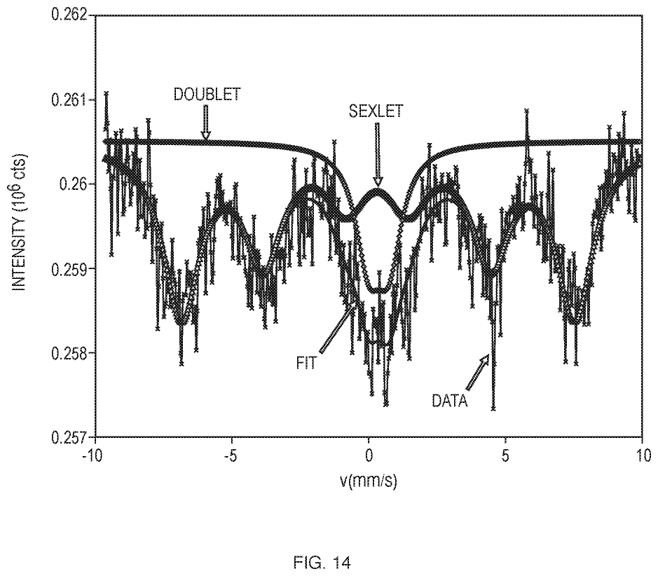

To get a better insight into the nature of Fe₃O₄ phase, Mössbauer spectroscopy was carried out for the 160Fe sample, since this sample had substantial amount of Fe for reliable Mössbauer signal. The room temperature (25° C.) Mössbauer spectrum of 160Fe of broad sextet indicates hyperfine magnetic component together with a central quadrupolar doublet, as shown in FIG. 14. The broadness of resonance lines in sextet is indication of small particle size and a distribution of hyperfine magnetic fields. The isomer shift (δ), quadrupolar splittings (Q.S.) and hyperfine field (B_{hf}) of the sextet are 0.32(5) mm/s, 0.016(6) mm/s, and 44.6(5)T, respectively, consistent with γ-Fe₂O₃ and rules of possibility of octahedral Fe²⁺ as in spinel Fe₃O₄, which produces another sextet subspectra with high δ value (˜0.63 mm/s). The δ and Q.S. for the quadrupolar splitting for the central doublet are 0.36 and 0.74 mm/s, respectively. The δ and Q.S. values for the central doublet are characteristic of Fe³⁺ ions in octahedral coordination, which may arise from the doping of Fe³⁺ in LMNO phase as hypothesized based on the TEM studies and shifting of PXRD lines of coated LMNO with respect to pristine sample.

In summary, the results from PXRD, TEM-SAED, STEM-EDS, and XPS strongly suggest that for the initial cycles of ALD, such as 5Fe and 10Fe, instead of deposition of thin film of iron oxide on the surface of the LMNO, some amount of Fe doping occurred. “Fe doping,” as the expression is used herein, means that in some valance state, iron ions penetrated into the lattice structure of LMNO. Although not being bound by theory, we believe that both the ALD formation of the Fe₃O₄ ultra-thin film stops and doping stops, which cessations could be due to saturation of surface defect sites. With increment in iron oxide ALL) cycles. Fe₃O₄ can be further oxidized to provide γ-Fe₂O₃, as here in the case of 160Fe.

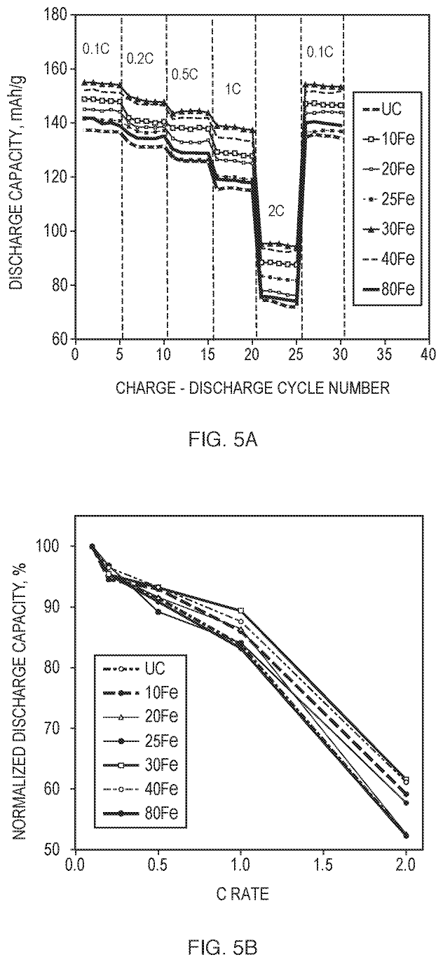

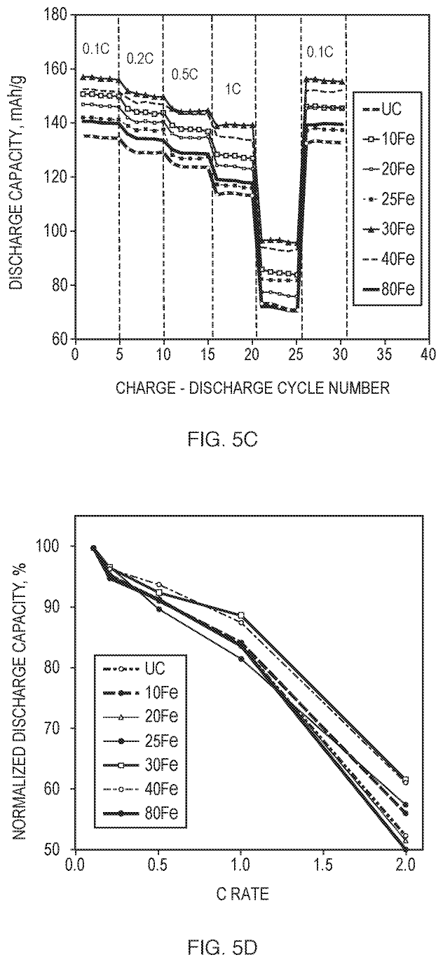

Electrochemical testing: The charge-discharge analysis was carried out in a 3.5 V-5 V voltage range. FIG. 5A and FIG. 5C show the discharge capacities of the UC, 10Fe, 20Fe, 25Fe, 30Fe, 40Fe and 80Fe samples that were discharged at different C rates, of 0.1C, 0.2C, 0.5C, 1C, and 2C, for five cycles at room temperature and 55° C., respectively. A C rate is a measure of the rate of discharge of a battery relative to its maximum capacity. For example, a 1C rate means that the discharge current will discharge the entire battery in 1 hour. For a battery with a capacity of 100 Amp-hrs, this converts to a discharge current of 100 Amps.

For these conditions, almost all the iron oxide ALD coated cells showed higher initial discharge capacity than the UC. We believe that the increased discharge capacity of iron oxide coated samples can be attributed to a synergetic effect between the doped Fe ion in the LMNO and conductive iron oxide overlayer on the LMNO particles.

In FIG. 5B, the normalized discharged capacities obtained at various C rates are plotted for all samples in reference to capacity obtained at 0.1 C. The results clearly demonstrate that the 30Fe sample shows superior rate capability as compared to other samples at room temperature. At 2C rate where charge/discharge cycle is about 30 minutes, the 80Fe sample performs poor due to the increased mass transfer resistance caused by the thicker coating. At 55° C., in FIG. 5D, a similar trend is observed. Overall the 30Fe sample performance is superior to that of any other coated or uncoated samples. At 2C rate, the 80 Fe sample performs more poorly as compared to room temperature testing due to degradation of cell performance at high temperature.

The diffusional and kinetic overpotential, solid electrolyte interphase (SEI) layer induced resistance, and contact/olunic resistance are the main cause of the voltage drop in a typical LIB. The term “overpotential” relates to a cell's voltage efficiency. The existence of overpotential relates to a loss of energy as heat. The ultrathin iron oxide ALD film can significantly alter most of these causes of the voltage drops. However, if the Li concentration ratio between the particle surface and the bulk is not affected by the coating, then the overpotential cause by the diffusional forces remains unchanged. The layer formed on the electrode surface (known as solid permeable interface) is usually much thinner than the SEI layer formed on the anode surface, and its thickness increases with charge-discharge cycling and the temperature.

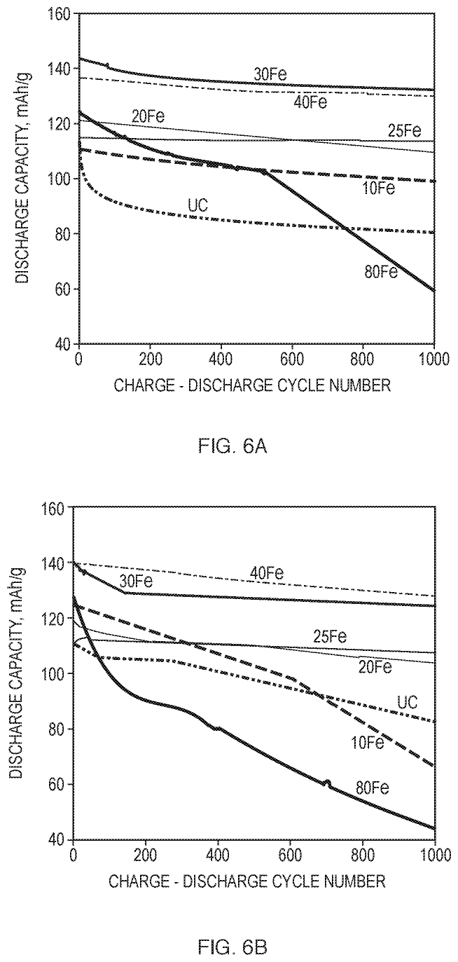

FIG. 6A shows the results of discharge cycling at a 1C rate between 3.5 V and 5 V for the UC, 10Fe, 20Fe, 25Fe, 30Fe, 40Fe, and 80Fe cells at room temperature up to 1,000 cycles. The discharge capacity of the UC was initially 114 mAh/g, and it declined to 80 mAh/g after 1,000 cycles. In contrast, the 30Fe and 40Fe samples exhibited much higher initial discharge capacities than the UC. The 30Fe showed a remarkable initial discharge capacity of 143 mAh/g, which is an approximately 25% increment compared to the UC. The difference between 30Fe and 40Fe became much less with increase in cycle numbers. The stable discharge capacity at approximatelyl33 mAh/g was maintained (which is 19 mAhlg higher than the UC cell's initial capacity) for the case of 30Fe even after 1,000 cycles. This means it dropped only by less than 7 percent, compared to its initial capacity. Similarly, 40Fe showed a remarkable approximately 95 percent capacity retention after 1,000 cycles at room temperature. This is the only time when 40Fe showed better results than 30Fe. The reason is not apparent, but it could be argued that the structural similarity of the iron oxide film and perhaps the amount of doped Fe are the reason that 30Fe and 40Fe showed very comparable results throughout this study. In addition, as seen in FIG. 6B, the ALD coated LMNO showed significantly improved cycling performance, even at an increased testing temperature of 55° C. The 30Fe and 40Fe cells exhibited an initial discharge capacity of 140 mAh/g. After 1,000 cycles, the capacity of 30Fe was stabilized at around 125 mAh/g after a gradual decrease from its initial capacity. The 30Fe and 40Fe cells showed much higher capacity than the UC cells, which indicated that iron oxide coated. LMNO particles were much more chemically and thermally stable.

The 10Fe samples showed higher initial capacity than the 20Fe and 25Fe, which is in agreement with the different C rate results; however in the long run, the capacity declined very significantly. This could be explained by the same reason that the Fe doped into the near surface structure of the LMNO helped improve the initial capacity of the material and the iron oxide coating, which occurred after more ALD cycles (as in 20Fe and 25Fe) gave stability to the material. The 80Fe sample showed poor stability over the testing time of 1,000 charge-discharge cycles. The reason could be that it has relatively thicker coating than other coated samples. The thick film induces more stresses during lithium ion insertion and deinsertion. These increased stresses combined with more mass transfer resistance of Lr due to the relatively thick films as compared to 30Fe/40Fe lead to poorer performance of the 80Fe sample, With increase in charge-discharge cycling, less Li⁺ inserted into electrode due to the increasing thickness of the SEI layer on lithium. This would explain the worst performance of the 80Fe sample.

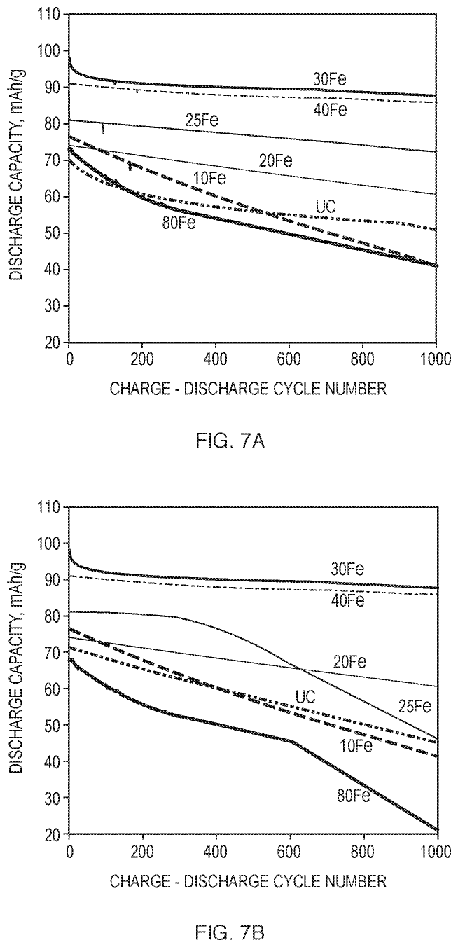

The drawback of coating on electrode particles is slower species transport. Consequently, a demonstration of performance improvement via ALD coatings at high C rate is significant because the diffusivity of ions in the solid phase becomes significant as the input current increases. Also, the inside temperature of a cell increases with faster charge-discharge cycle rate, and that also increases the stress level due to developed concentration gradient inside particles. There is also a possibility of phase transition at the particle surface from over-lithiation during this cycling process. Therefore, in order to examine the performance of these coated cells, they were cycled at 2C rate, shown in FIG. 7. The performance of 10Fe improved slightly due to initial iron doping. The trend is similar to the test at 1C rate as discussed earlier, and the higher initial capacity of 10Fe did not last longer than 20Fe and 25Fe coated samples. A conformal coating of iron oxide with a larger number of ALD coating cycles provided a protection, which resulted in a significant improvement in initial capacity fade and remarkable stable performance, as in the case of 30Fe. The 30Fe and 40Fe still had far better discharge capacity and stability than the UC cell, even after 1,000 cycles at a 2C rate. The 30Ce and 40Fe showed more than 90% capacity retention after 1,000 cycles, while the UC cell could not withstand the high rate of charge-discharge cycling and the capacity kept dropping. Overall, 30Fe cells performed consistently better than any other prepared cells. The excellent cycling behavior of the iron oxide ALD-coated LMNO, iron doped electrodes, compared to the UC cell, clearly indicates that the synergetic effect of ALD deposited iron oxide coating and Fe doping into the LMNO structure (see PXRD results and SAED patterns in FIG. 4 and FIG. 11, respectively) could well be the reason for the significantly improved electrochemical performances even at high C rates and high temperature cycling.

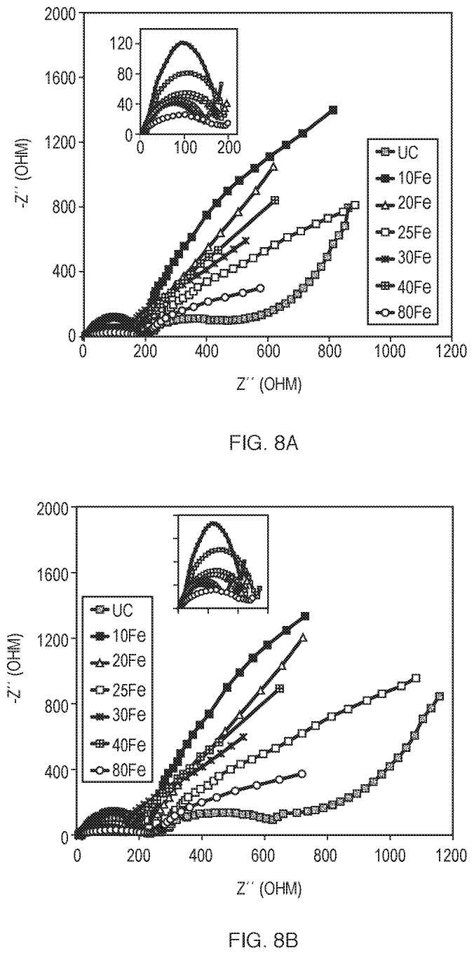

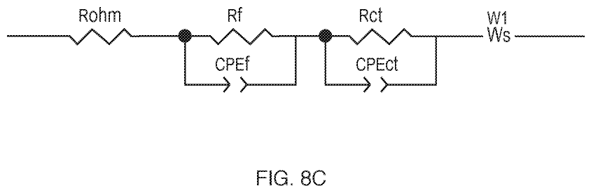

The interface change due to ALD thin film coating was further investigated using electrochemical impedance spectroscopy (EIS). See FIG. 8A, FIG. 8B, and FIG. 8C. A three electrode configuration was used for EIS measurements. The electrode in the coin cell served as the working electrode whereas the Li metal anode served as both the reference and the counter electrode. All the impedance measurements were performed at open circuit voltage (OCV). The impedance spectra were fitted using equivalent circuit that consisted of three resistance elements, two constant phase elements and a warburg diffusion element (see FIG. 8C). Among the fitted parameters, ohmic resistance (Rₒₕₘ), charge-transfer resistance (R_{ct}), and surface film resistance (R_{f}) can be used to quantify the polarization behaviors. The W1 element represents the warburg impedance which can be used to quantify Li-ion mass transfer resistance.

Table 1A at room temperature and Table 1B at 55° C. below provide impedance parameters using equivalent circuit models for electrodes made of pristine, 10Fe, 20Fe, 25Fe, 30Fe, 40Fe, 80Fe coated LiMn_{1.5}Ni_{0.5}O₄ particles:

TABLE 1A

| | | | | | | | | | | | Warburg Short | | | | | |
|---|---|---|---|---|---|---|---|---|---|---|---|---|---|---|---|---|
| | Rₒₕₘ(Ω) | | R_{f}(Ω) | | R_{ct}(Ω) | | C_{f}(μF) | | C_{ct}(μF) | | R_{w}(Ω) | | τ(s) | | P | |
| RT | 0^{th} | 1000^{th} | 0^{th} | 1000^{th} | 0^{th} | 1000^{th} | 0^{th} | 1000^{th} | 0^{th} | 1000^{th} | 0^{th} | 1000^{th} | 0^{th} | 1000^{th} | 0^{th} | 1000^{th} |
| UC | 4.9 | 5.8 | 25.1 | 30.1 | 175.2 | 210.2 | 17.54 | 21.05 | 6.12 | 1.29 | 5324 | 6678 | 100.8 | 171 | 0.81 | 0.63 |
| 10 Fe | 9.8 | 11.7 | 15.4 | 18.5 | 170.6 | 187.7 | 15.42 | 16.96 | 4.65 | 2.98 | 1205 | 2400 | 52.45 | 55.98 | 0.68 | 0.58 |
| 20 Fe | 11.76 | 14 | 20.2 | 24.2 | 171.9 | 189.1 | 11.2 | 12.32 | 4.06 | 1.87 | 2240 | 6332 | 21.6 | 44.1 | 0.51 | 0.66 |
| 25 Fe | 7.84 | 9.3 | 22.1 | 26.5 | 165.5 | 182.1 | 10.45 | 11.5 | 2.15 | 2.05 | 2803 | 5232 | 27.9 | 46.8 | 0.65 | 0.77 |
| 30 Fe | 8.82 | 10.5 | 13.5 | 16.2 | 135.1 | 141.9 | 4.6 | 3.47 | 2.72 | 0.98 | 2642 | 4199 | 7.263 | 9.45 | 0.75 | 0.82 |
| 40 Fe | 10.78 | 12.8 | 14.5 | 17.4 | 145.2 | 152.5 | 6.5 | 7.52 | 3.5 | 0.21 | 3240 | 4210 | 10.78 | 11.12 | 0.59 | 0.49 |
| 80 Fe | 9.8 | 11.7 | 19.5 | 23.4 | 180.6 | 216.7 | 1.2 | 10.47 | 5.9 | 4.02 | 2529 | 2952 | 76.5 | 112.5 | 0.49 | 0.31 |

TABLE 1B

| | Rₒₕₘ(Ω) | | R_{f}(Ω) | | R_{ct}(Ω) | | C_{f}(μF) | |
|---|---|---|---|---|---|---|---|---|
| 55° C. | 0^{th} | 1000^{th} | 0^{th} | 1000^{th} | 0^{th} | 1000^{th} | 0^{th} | 1000^{th} |
| UC | 5.39 | 6.41 | 31.38 | 37.65 | 219 | 262.8 | 21.93 | 26.31 |
| 10 Fe | 10.78 | 12.83 | 16.94 | 20.33 | 187.66 | 206.43 | 16.69 | 18.66 |
| 20 Fe | 12.94 | 15.39 | 22.22 | 26.66 | 189.09 | 208 | 12.32 | 13.55 |
| 25 Fe | 8.62 | 10.26 | 24.26 | 29.11 | 182.05 | 200.26 | 11.5 | 12.64 |
| 30 Fe | 9.7 | 11.55 | 14.89 | 17.87 | 148.61 | 156.04 | 5.06 | 3.82 |
| 40 Fe | 11.86 | 14.11 | 15.97 | 19.17 | 159.72 | 167.71 | 7.15 | 8.27 |
| 80 Fe | 11.86 | 14.11 | 23.6 | 28.31 | 218.53 | 262.23 | 1.45 | 12.67 |
| | | | Warburg Short | | | | | |
| | C_{ct}(μF) | | R_{w}(Ω) | | τ(s) | | P | |
| 55° C. | 0^{th} | 1000^{th} | 0^{th} | 1000^{th} | 0^{th} | 1000^{th} | 0^{th} | 1000^{th} |
| UC | 7.65 | 1.61 | 6655 | 8347.5 | 126 | 213.75 | 0.78 | 0.65 |
| 10 Fe | 5.12 | 3.28 | 1325.5 | 2640 | 57.7 | 61.6 | 0.8 | 0.6 |
| 20 Fe | 4.47 | 2.08 | 2464 | 6965.2 | 23.8 | 48.5 | 0.6 | 0.7 |
| 25 Fe | 2.37 | 2.26 | 3083.3 | 5755.2 | 30.7 | 51.5 | 0.7 | 0.9 |
| 30 Fe | 2.99 | 1.08 | 3205 | 4765 | 8 | 10.4 | 0.8 | 0.9 |
| 40 Fe | 3.85 | 0.23 | 3564 | 4631 | 11.9 | 12.2 | 0.7 | 0.5 |
| 80 Fe | 7.14 | 4.86 | 3060 | 3571.9 | 92.57 | 136.13 | 0.5 | 0.5 |

Table 1 provides the list of all the fitted parameters value obtained after fitting the impedance curves to an equivalent circuit . The semicircle from the impedance analysis of all the cells was fitted using a combination of two R|C units (resistodcapacitor) to represent surface-film and charge-transfer resistance, R_{(f+ct)}. For clarification, the lines in resultant impedance curves were not obtained after fitting the equivalent circuit to the impedance curves. One semicircle was observed for the UC and the iron oxide ALD coated cells, as shown in FIG. 8. Upon a close look at the semicircle, it reveals that they in fact are two semicircles overlapped, which could be contributed from the SEI film (at higher frequency region) and the charge-transfer resistance at the particle surface (at mid to high frequency regions). After the 1^{st} and 1,000^{th} charge-discharge cycles, the radius of the semicircles of 30Fe and 40Fe cells are smaller in comparison to the UC cell, as evident in FIG. 8A and FIG. 8B. With the increase in the thickness of iron oxide ALD films, the radius of the semicircle increased, as in the case of 80Fe, which was mainly due to the increased charge-transfer resistance (see Table 1), indicating that the sluggish transit of Li through the longer pathway. After 1,000 charge-discharge cycles, the warburg resistance (the element that is representative of Li⁺ ion diffusion resistance) was highest for the UC sample as compared to the coated samples. The charge transfer resistance first decreased with increase in number of ALD coating cycles, reached a minimal value for the 30Fe sample and then increased with the increase in ALD coating cycles. This trend is indicative that 30Fe sample has the optimal thick coating as compared to the others. The film resistance also followed a similar trend as the ultrathin film is conductive, it decreased the film resistance initially and with increase in thickness of the film, the film resistance also increased.

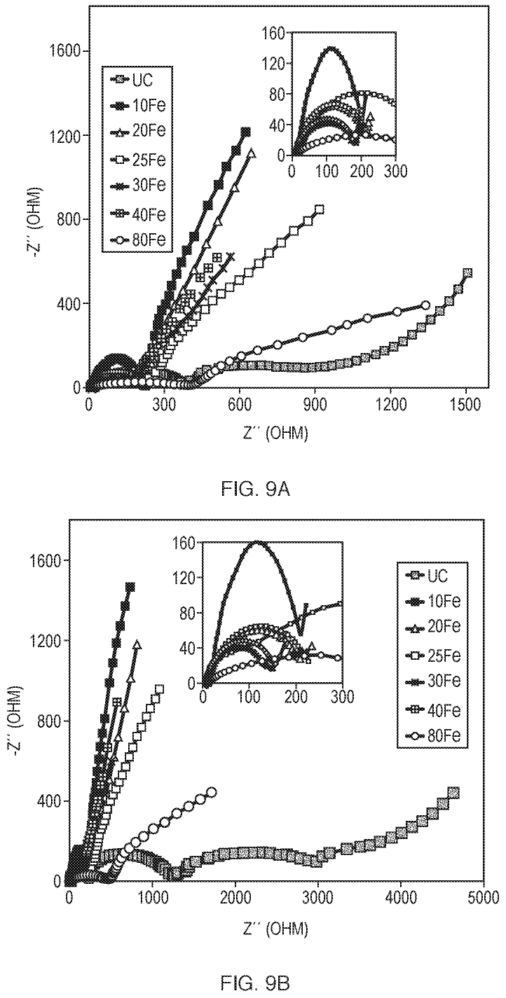

EIS study was also performed at high temperature (55° C.), as shown in FIG. 9. The UC sample experienced much more increment in charge transfer resistance than the iron oxide ALD coated samples except for the 80Fe sample. The higher impedance of the UC sample at elevated temperature has been attributed to the degradation reactions between the electrode and the electrolyte. As discussed above, the 80Fe experienced large stresses coupled with high mass transfer resistance due to the relatively thick coating. That could be due to high charge transfer resistance from the distorted lattice structure. Comparing the impedance parameters of the 30Fe and 40Fe cells with the UC cell, it is clear that the UC cell was experiencing slower kinetics after cycling.

The 30Fe cell showed the best results among all the other cells tested. With increase in charge-discharge cycling, the charge-transfer and the film resistance increased, and the difference between the UC cell and the coated cells grew significantly. For example, after 1,000 charge-discharge cycles, the combined film and charge transfer resistance of the 30Fe was 173.9 Ω, while it was 300.3 Ω for the UC cell, which was greatly increased from the value of the fresh cell. The resistance values explain that the kinetics of the surface film developed on the electrodes. Rₒₕₘ values for the UC sample and the other samples are not the same. The difference could be due to the structure modification of LMNO by iron doping and iron oxide coating. The 30Fe sample performs the best as compared to the other samples. This is because of the lowest charge transfer and film resistance of the 30Fe sample. For the 20Fe sample, the film was just not thick enough to provide good protection as compared to the optimal coating of 30Fe. Lower charge transfer and film resistance could also mean that more Li⁺ ions are available at the 30Fe electrode surface, thereby compensating for increased diffusion resistance. The lower film resistance is due to the conductive iron oxide film coating. The trend of the charge transfer and the film impedance values confirm that the 30Fe sample has the optimal ultrathin coating of iron oxide.

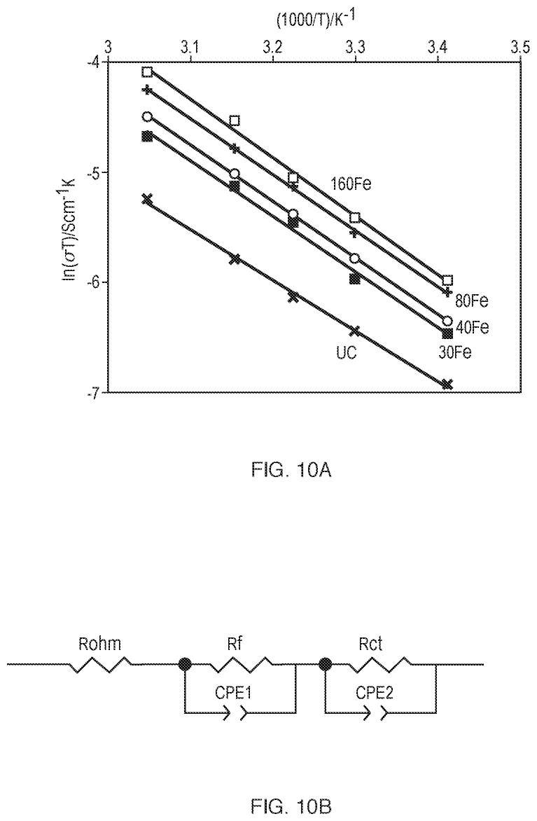

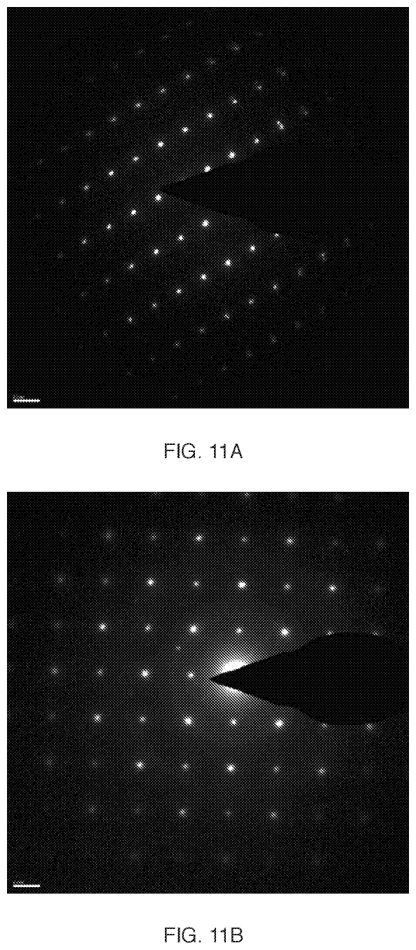

Pellets of only the UC (uncoated), 20Fe, 30Fe, 40Fe, 80Fe, and 160Fe particles were prepared for the conductivity measurements. The ac complex plane impedance analysis was used for the experiment and the same impedance analyzer was used to obtain the impedance curves shown in FIG. 10A. The equivalent circuit used to fit the impedance curves is shown in FIG. 10B. The equivalent circuit does not contain the Warburg element as there is no conduction or movement of ions during this experiment. (The Warburg element represents the impedance of semi-infinite diffusion to/from flat electrode.) The obtained film resistance (Rf) and charge transfer resistance (Rct) are combined in series to obtain an equivalent resistance value which is used for conductivity calculations. For measuring the resistivity, the pellet thickness and diameter is found from which the area is calculated. This procedure helps us to calculate only the mixed ionic and electronic conductivities.

FIG. 10A shows a comparison of the results among the uncoated and the coated samples, which were prepared using the same procedure and material compositions. The comparison shows that it is certain to conclude that iron oxide coating can improve the conductivity of the LMNO particles, The 160Fe shows the best conductivity compared to any other samples, which could also be true due to the presence of highly conductive Fe₃O₄ (or γ-Fe₂O₃). This is in contrast to our previous work, wherein the highest conductivity was achieved with an optimum CeO₂ thickness of 3 nm. In the present case, the iron oxide film growth rate was very low (the thickness of 160 cycles of iron oxide ALD is only 3 nm) and, hence it is thin enough to provide better conductivity for the coated samples with higher number of ALD cycles. The conductivity has been found to obey the Arrhenius equation

$$σ \cdot T = {σ}_{0} \cdot exp ( \frac{- {E}_{a}}{{k}_{B} T} ) \qquad ( 1 )$$

where, σ₀ is the pre-exponential factor, k_{B} is the Boltzmann contant, T is the absolute temperature, and Eₐ is the activation energy for Li ion movement. FIG. 10A shows the direct correlation between the mixed conductivity and the temperature (a linear Arrhenius plot), Because the testing temperature were limited to 328 K, there was no phase or structural change observed during the measurements.

Conclusions: We have successfully demonstrated that the cycle life and the capacity retention of LMNO can be significantly improved by the synergistic or synergetic effect of ultrathin film coating of iron oxide by ALD combined with the simultaneous Fe ionic doping near the surface of the LMNO particles. The ionic Fe penetration into the lattice structure of LMNO was verified by cross-sectional STEM-EDS of iron oxide coated samples and the ultra-thin iron oxide films were directly observed by TEM. Mössbauer and XPS results confirmed the valance state of the iron for the ALD coated samples. It can be seen that the 30Fe sample has a high initial capacity of 143 mAh/g, which is about 25% higher than that of the UC sample. It shows 93% capacity retention after 1,000 cycles at room temperature. More importantly, at elevated temperatures, the 30Fe sample performs the best as compared to the UC sample and other iron oxide coated samples. We herein report for the first time the synergistic effect of doping and thin film coating on LMNO particles.

The foregoing data shows that an ALD coating of iron oxide provided much better improvement in performance of LMNO than what could potentially be due to only doping effect. ALD has the potential to prepare these ultrathin electrochemically active films with optimal thickness and synergetic effect of simultaneous conductive coating and element doping, providing novel electrodes that are durable as well as functional at high temperature and fast cycling rates. Further in depth analysis of this novel product and method could provide a major breakthrough in solving the current problems in the field of energy storage.

### Exemplification

### Methods Used:

### ALD Coating of LMNO Particles

The ALD coating was carried out in a fluidized bed reactor, by methods known in the art and described below. There are filters employed to contain the particles in the reactor, while allowing only gas to pass. Ferrocene (99% pure, from Alfa Aesar®) and oxygen (99.9%) were used as precursors, and were delivered into the reactor in alternate doses at 450° C.. Ferrocene was delivered into the reactor using a heated bubbler and nitrogen was used as a carrier gas. Then N₂ was used to purge the reactor to remove any unreacted ferrocene and by-products. After that, O₂ was fed into the reactor, followed by another N₂ purge. All lines were heated to 120° C. to avert any vapor deposition. In one embodiment of the disclosed method, the steps are substantially as follows.

Step 1. The particle ALD coating was carried out in a fluidized bed reactor (FBR). The FBR is connected to a steel plate and it is balanced on four large springs which helps isolate the vibration generated from two three-phase AC Fibro-motors (Martin Engineering, IL, USA). The vibration frequency is controlled by speed controller (VS1MX, Baldor Drives, St. Louis, Mo.). The LiMn_{1.5}Ni_{0.5}O₄ particles (NANOMYTE® SP-10, 4-5 μm, NEI Corporation. USA) to be coated were introduced into reactor. Filters were employed to contain the particles in the reactor, while allowing only gas to pass. Then the temperature was increased to a point using a split-furnace (CM Furnaces Inc., NJ, USA) wherein the surface reaction could occur. After that, the minimum fluidization velocity was measured using LabView® program and then the particles were outgassed for 5 hrs at 250° C.

Step 2. Ferrocene (99% pure, from Alfa Aesart, USA) and oxygen gas (99.9%, Airgas Inc., St. Louis, Mo.) were used as precursors, and were delivered into the reactor in alternate doses at 450° C. Ferrocene was delivered into the reactor using a heated bubbler (115° C.) and nitrogen gas (99,99%, Airgas Inc., St. Louis, USA) was used as a carrier gas. Then N₂ was used to purge the reactor to remove any unreacted ferrocene and by-products. All the gases were controlled using mass flow controllers (MKS Instruments Inc., USA). After that, O₂ was fed into the reactor, followed by another N₂ purge, All lines were heated to 150° C. to avert any vapor deposition inside the lines. The ALD process has two half-reactions for the two precursors to complete one ALD cycle. ALD process was controlled precisely using a custom-made LabView® program. First, the ferrocene was introduced into the reactor to react with the native hydroxyl groups present on the surface, and then the unreacted precursor and any by-products were flushed out of the reactor using nitrogen (inert) gas. The reactor was purged with vacuum, and then only the second precursor was introduced in the reactor. Again, the unreacted precursor and any by-products were flushed out of the reactor using inert gas. The reactor was purged with vacuum.

Step 3. We repeated the process described in step 2.

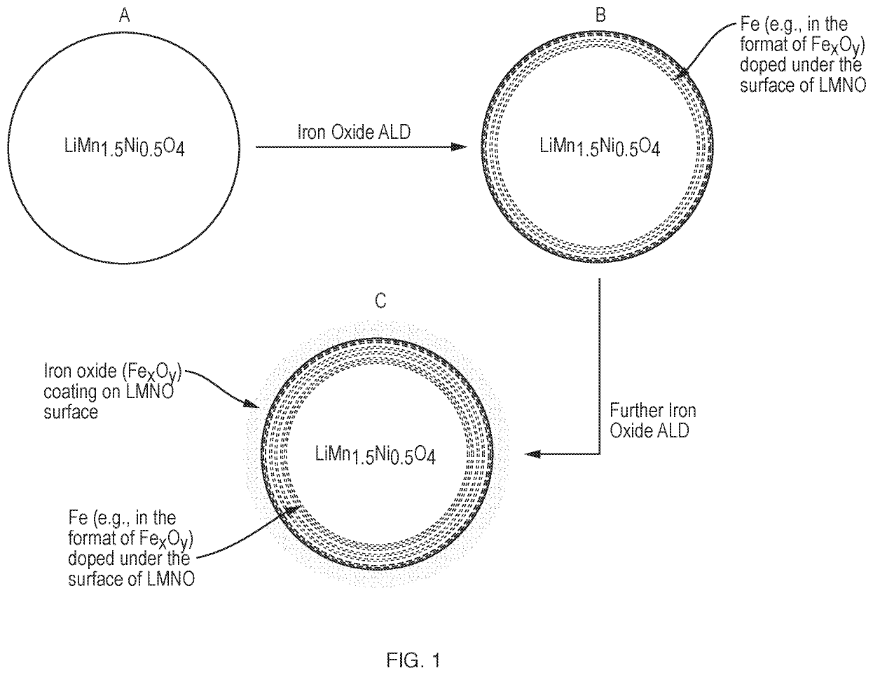

Step 4. We stopped the reaction cycles. First, we cooled down the reactor and the precursor bubbler to room temperature, meanwhile passing the nitrogen gas through the reactor. The product of the disclosed process comprises doped and coated LiMn_{1.5}Ni_{0.5}O₄ particles, an embodiment of which is shown schematically in FIG. 1.

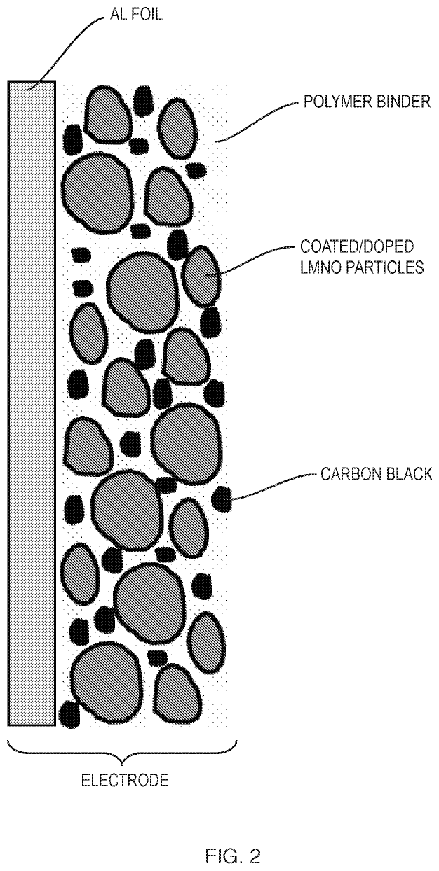

An 80:10:10 wt. % mixture of LiMn_{1.5}Ni_{0.5}O₄, carbon black (Super P conductive, 99+%, Alfa Aesar, USA) and polymer binder poly(vinylidene fluoride) (Alfa Aesar, USA) was used to prepare electrodes. The slurry of the mixture was spread on the aluminum-foil, and then it was dry-heated at 120° C. The electrode discs were made after punching the coated foil. The reference/counter electrode was Li metal (99,9% trace metal basis, Sigma-Aldrich, USA) and LiPF₆ (1 mol/L in a mixed solvent of ethylene carbonate, dimethyl carbonate, and diethyl carbonate with a volume ratio of 1:1:1, MTI Corporation) in all the cells prepared. The CR2032 cells fabrication was carried out in an Ar-filled glove box. An embodiment of the disclosed electrode is schematically shown in FIG. 2.

The charge-discharge analysis was carried out using an 8-channel battery analyzer (Neware Corporation) for 3.5 to 5 V potential range at various C rates, and at different temperatures (room temperature and 55° C.). The electrochemical impedance spectroscopy of the prepared cells were carried out using an IviumStat impedance analyzer. The EIS analysis was performed at 5 mV and 0.01-1M Hz frequency range. Conductivity measurements were carried out using the same analyzer for cold pressed pellets of the samples. The pellets were coated with Ag (paste from Sigma Aldrich) on both sides to act as the blocking electrodes. These pellets were vacuum-dried at ˜85° C. for 6 hr. The analyses were performed for a range of 1 Hz to 1 MHz and at 1 mV. The test temperature range was 20° C. to 55° C. The spectra were analyzed using Zview software (Scribner Associates, Inc.). The conductivity tests were performed to compare the coated and uncoated samples and to examine the conductive nature of the coating with respect to the substrate only. Necessary steps were taken to make sure that all the cells and pellets were exposed to the same conditions for their respective batches of experiments.

### Structural Characterization

Inductively coupled plasma-atomic emission spectroscopy was used to quantify the mass percent of iron on the particles. The iron oxide films were verified using a FEI Tecnai F20 field emission gun high resolution TEM equipped with energy dispersive X-ray spectroscopy (EDS) system. To check the Fe element distribution within the particles, about 80 nm thick thin section across the center of the particle was prepared by focused ion beam, using an FEI Q3D dual-beam system. The thin section was subsequently checked by a JEOL 2010F TEM in both TEM mode and scanning TEM mode at 200 kV acceleration voltage.

The crystal structure of the uncoated and coated particles was determined via powder X-ray diffraction (Phillips Powder Diffractometer, CuKα radiation, λ=1.5406 Å). The PXRD analysis was performed using a scan rate of 2°/min and a step size of 0.2°.

The selective area electron diffraction (SAED) patterns obtained, aligned along their main axis, from the UC and the 160Fe samples shown in FIG. 11A and FIG. 11B, respectively, clearly demonstrated the differences in the structure for LiMn_{1.5}Ni_{0.5}O₄ (LMNO) before and after iron oxide ALD coating, which was also confirmed by unidentified peaks in PXRD spectra of 160Fe (FIG. 4). In comparison, pristine LMNO showed fewer lattice peaks in the spinal diffraction pattern in the (100) zone than the 160Fe. These extra peaks, for the case of 160Fe, correspond to the cubic phase (P4332).

X-ray photoelectron spectroscopy (XPS, Kratos Axis 165) was used to study the oxidation state of Fe by employing Al K (α) excitation, operated at 150 W and 15 kV. The peaks were corrected with C 1s at 284.6 eV. The values for the Fe2p_{3/2} peak reported in the literature differ by 0.9 eV between two extreme values 710.6 eV and 711.5 eV. As shown in FIG. 13, the UC sample shows no peak of Fe, expectedly, while the 30Fe and 40Fe samples show a very sharp peak of Fe 2p at 711.5 eV, which is very close to the observed Fe (III) 2p_{3/2} in Fe₂O₃. Also, these two samples show a small peak at 724 eV, which is very close to the observed peak of Fe (II) 2p_{1/2} in Fe₂O₃. This indicates that the iron oxide deposited by ALD is Fe₃O₄ or mixture of FeO and Fe₂O₃ as peaks for Fe (II) as well as Fe (III) oxidation state were observed.

For 40Fe, a faint peak at 710.1 eV represents Fe₃O₄. That could explain an overall slightly better result of 30Fe compared to 40Fe. Also, a small peak broadening at 707 eV was observed in the XPS spectra of 30Fe and 40Fe indicates that there could be Fe with different valance state in the 30Fe and 40Fe sample. There is also a small satellite peak at ˜717 eV in the 30Fe and 40Fe samples, which indicates the existence of Fe₂O₃, as reported previously. Iron at an intermediate oxidation state in Fe₃O₄ with a mixture of Fe(II) and Fe (III) presents a BE value of 710.2 eV. The Fe³⁺ component of Fe 2p_{3/2} in γ-Fe₂O₃ is at 710.1 eV. The peak-shifts for 30Fe, 40Fe, and 80Fe samples are because the main difference between the two sets of samples is coordination of the Fe³+cations. In the α-compounds, the crystal structure is oriented in such a way that all of the cations are octahedrally coordinated. In the γ-compounds, on the other hand, three-quarters of the Fe³+cations are octahedrally coordinated whereas the other quarter of the cations are tetrahedrally coordinated. This also explains the satellite peaks, as proven in literature, the XPS Fe 2p spectrum of 40Fe possesses smaller satellite intensity as compared with that of 30Fe due to the larger Fe 3d to O 2p hybridization in 40Fe, which has higher amount of γ-Fe₂O₃. The formation of a conformal iron oxide, e.g., Fe₂O₃ ALD layer on the surface can act as an artificial solid permeable interface (SPI) layer and helps prevent electrolyte decomposition at higher voltage. The PXRD and SEED results indicate that Fe in some form of oxidation state has penetrated into the lattice structure of LMNO.

Fe Mössbauer spectroscopy was performed on the as-prepared, chemically oxidized, and different state-of-charge electrode materials in transmission aeometry using a constant acceleration spectrometer equipped with a ⁵⁷Co (25 mCi) gamma source embedded in Rh matrix. The instrument was calibrated for velocity and isomer shifts with respect to α-Fe foil at room temperature. The resulting Mössbauer data were analyzed using Lorentzian profile fitting by RECOIL software.

Recent studies have shown that there were oxygen vacancies in Fd3m disordered structure of LMNO. It was also said that these defects were in the diffusion path of lithium ions (Li⁺). During iron oxide ALD process, a typical cycle involves introducing gaseous precursors into the reactor system in a sequence ensuring no mixing of both the precursors. It is proposed that during the ferrocene dose, half surface reaction that leads to formation of Fe ions on the surface of I:NINO could penetrate inside the lattice structure in some valance state due to the defects present in Li⁺ diffusion path. This occurred during initial cycles of iron oxide ALD. After the defect sites were saturated with Fe, conformal iron oxide film would form on the surface of LMNO particles. The doping of Fe near the surface of the coating coupled with the ultrathin optimal iron oxide are responsible for significant enhancement of cycleability, improvement in initial specific capacity and high capacity retention. This also helps explain the discrepancy between the observed thickness of iron oxide films on LMNO particle surfaces by TEM and the calculated film thickness based on iron content on LMNO particles from ICP-AES analysis.

### Equivalents

While this invention has been particularly shown and described with references to preferred embodiments thereof, it will be understood by those skilled in the art that various changes in form and details may be made therein without departing from the scope of the invention encompassed by the appended claims.

What is claimed is:

1. An electrode comprising at least one electrode particle comprising:
a source of lithium ions,
a coating of an oxide of a transition metal on the surface of the electrode particle, and
the transition metal ions and/or the elemental transition metal doped under the surface of the electrode particle.

2. The electrode of claim 1, wherein the source of lithium ions comprises LiMn_{1.5}Ni_{0.5}O₄.

3. The electrode of claim 1, wherein the source of lithium ions comprises at least one of LiCoO₂, LiMn₂O₄, Li₄Ti₅O₁₂, Li₂MnO₃, and Lithium Nickel Manganese Cobalt Oxide (LiNiMnCoO₂).

4. The electrode of claim 3, further comprising a layered LiMO₂ component or a spinel LiM₂O₄ component, wherein “M” comprises at least one of Mn and Ni.

5. The electrode of claim 1, wherein the source of lithium ions comprises LiNiₓCo_{y}Al_{z}Oₐ.

6. The electrode of claim 1, wherein the at least one electrode particle comprises a transition metal oxide film coating of from about 0.1 nanometer to about 500 nanometers.

7. The electrode of claim 1, wherein the at least one electrode particle comprises a transition metal oxide film coating of from about 0.2 nanometer to about 200 nanometer.

8. The electrode of claim 1, wherein the at least one electrode particle comprises a transition metal oxide film coating of from about 0.4 nanometer to about 100 nanometers.

9. The electrode of claim 1, wherein the at least one electrode particle comprises a transition metal oxide film coating of from about 0.6 nanometer to about 50 nanometers.

10. The electrode of claim 1, wherein the at least one electrode particle comprises a transition metal oxide film coating of from about 0.2 nanometer to about 1 nanometer.

11. The electrode of claim 1, wherein the at least one electrode particle comprises a transition metal oxide film coating of about 0.6 nanometer.

12. The electrode of claim 1, wherein the transition metal is iron and the transition metal ions and/or the elemental transition metal doped under the surface of the electrode particle are iron ions or elemental iron.

13. The electrode of claim 1, wherein the transition metal is cobalt and the transition metal ions and/or the elemental transition metal doped under the surface of the electrode particle are cobalt ions or elemental cobalt.

14. The electrode of claim 1, wherein the transition metal is nickel and the transition metal ions and/or the elemental transition metal doped under the surface of the electrode particle are nickel ions or elemental nickel.

15. An electrode comprising:
a metal or a carbon substrate at least partially coated with a mixture comprising a plurality of electrode particles, each electrode particle comprising a source of lithium ions,
a coating of iron oxide on the surface of the electrode particle, and iron ions and/or elemental iron doped under the surface of the electrode particle; and
a polymer binder.

16. A method of transition metal doping of lithium ion battery electrode particles while simultaneously, using atomic layer deposition, forming an ultra-thin film coating of the transition metal oxide on the lithium ion battery electrode particles so as to effect a synergistic or synergetic result.

17. The method of claim 16, wherein the transition metal doped is iron and the ultra-thin film coating is iron oxide.

18. The method of claim 16, wherein the transition metal doped is cobalt or nickel and the ultra-thin film coating is cobalt oxide or nickel oxide, respectively.
